(19) United States
(12) Patent Application Publication
(10) Pub. No.: US 2003/0050971 A1
(43) Pub. Date: Mar. 13, 2003

(54) Client server system and method therefor

(75) Inventors: Junichi Okuyama, Ashigarakami-gun (JP); Yasutoshi Maeda, Ashigarakami-gun (JP); Koh Kamizawa, Ashigarakami-gun (JP); Katsuya Mitsutake, Ashigarakami-gun (JP); Koichi Yoshimura, Ashigarakami-gun (JP)

Correspondence Address: OLIFF & BERRIDGE, PLC, P.O. BOX 19928, ALEXANDRIA, VA, 22320, US

(73) Assignee: FUJI XEROX CO., LTD., Tokyo (JP)

(21) Appl. No.: 10/097,618

(22) Filed: Mar. 15, 2002

(30) Foreign Application Priority Data
Sep. 10, 2001 (JP) 2001-273530
Sep. 18, 2001 (JP) 2001-282662

(51) Int. Cl. G06F 15/16

(52) U.S. Cl. 709/203

(57) ABSTRACT

A service history generation section employs stored information to generate a service history indicating whether a pertinent server can provide a service for an arbitrary client device and an arbitrary server. A history requesting section requests the server to notify a service history via a network. Upon receiving the request from the client device, a history notification section notifies a service history to the requesting source client device. A server selection section then displays the service history received from the server as a UI image for a user, and in accordance with the user's manipulation, selects an appropriate server for the execution of the service.

### BACKGROUND OF THE INVENTION

1. Field of the Invention

The present invention relates to a client server system in which a client device and a server are connected via a network.

Further, the present invention relates to a service notification method for a client server system, the method for notifying to a client device service information provided by a server.

Furthermore, the present invention relates to a server selection method in which a client device selects a server based on the notified service information.

In addition, the present invention relates to a program enabling the server and the client device to execute the above described methods.

2. Description of the Related Art

A client server system has been employed in which a client device and a server are connected via a network and the server provides a service in response to a request from the client device.

FIG. 1 is a diagram showing an example of client server system.

As is shown in the example in FIG. 1, a server is employed. The server is connected to a network and performs a process upon receiving a process request and an input to output a process result.

As a trend, such a server will be represented by a greater variety. It is important to select an optimal information processing apparatus from many information processing apparatus.

For example, the server shown in FIG. 1 may be employed for a conversion process of thing, which physically exists, or an image to which the thing is imported into electronic information, that is, a conversion process of a paper document (printed material or the like) into an electronic document (image data or the like ) or a conversion process of the electronic document into the paper document. In this case, in order to select an optimal server, it is necessary to consider many factors such as an attribution of the image to be converted (color/monochrome, number of pages, number of copies, or the like), an attribution of the server (color/monochrome, process speed, or the like), or information relating to management such as use right.

FIGS. 2 to 4 are first to third diagrams showing first to third processes that are performed by making a plurality of servers cooperate with each other.

Further, as shown in FIGS. 2 to 4, when a plurality of types of servers are combined to perform a process, it is necessary to find an appropriate combination from many combinations of attributions of a paper document, attributions of a digital document, and attributions of servers. It is, therefore, difficult to select an optimal server.

As an example of a method for selecting a server, a method in which database is employed is possibly considered.

However, in the method in which the database is employed, it is necessary for manager of a computer network to register and manage a server connected to the computer network on the database and for user of a server to select an appropriate server with reference to the database.

According to this method, as kinds and number of servers are increasing, burden on the manager is increasing. Further, a server, which is not known to the manager, is not registered on the database.

A method for selecting a server based on utilization past record (history) of the server in the past is possibly considered.

In this method, an apparatus, which has requested a process, or the like holds information such as an address of process request destination as a history. When the same process request is issued, process request destination is selected with reference to the history.

For example, as a method for supporting a user who intends to utilize the server from the client device, “JP-A-2000-172469” (reference document 1) discloses a method comprising the steps of storing setting information into a printer and automatically selecting the setting information.

Further, “JP-A-2000-148425” (reference document 2) discloses a method comprising the steps of managing information for a print shop, analyzing an order, and selecting an appropriate print shop.

However, an apparatus other than the apparatus itself which holds the history can not refer the history.

The invention is made in view of the above described problems in the related art. An object of the invention is to provide a client server system which refers service history or service attribution held in an apparatus by which user performs a conversion process from other apparatus when a job is executed by combining a plurality of many kinds, various, and many servers connected to a computer network to perform cooperation process and thereby can select an optical combination of servers for execution of the job. Another object of the invention is to provide a server selection method.

### SUMMARY OF THE INVENTION

In order to accomplish the above objects, a client server system according to the invention has a plurality of servers for providing a predetermined services, respectively, and at least one client device for requesting a service for the servers, in which the at least one client device has a notification request section for requesting each of the plurality of servers to transmit at least one of a service history indicating a history of a service and service attribution information indicating an attribution of a service to be provided, a server selection section for selecting at least one of the plurality of servers based on the at least one of the service history and the service attribution information, which is transmitted from the servers in accordance with the request, and a service request section for requesting a service for the selected server, and each of the servers has at least one of a service history generation section for generating the service history and a service attribution generation section for generating the service attribution information, and a notification section for transmitting the at least one of the service history and the service attribution information in response to the request from the client device.

A second client server system according to the invention has a plurality of servers for providing predetermined services, respectively, a first client device for requesting a service for each of servers, and a second client device, in which the first client device has a notification request section for requesting notification of at least one of a service history indicating a history of service and service attribution information for each of the plurality of servers, a server selection section for selecting at least one of the plurality of servers based on the at least one of the service history and the service attribution information transmitted from the second client device in response to the request, and a service request section for requesting a service for the at least one selected server, and the second client device has at least one of a service history generation section for generating the service history and a service attribution information generation section for generating the service attribution information, and a notification section for notifying the at least one of the generated service history and the generated service attribution information in response to the request from the first client device.

A third client server system according to the invention has a plurality of first servers for providing predetermined services, respectively, at least one client devices for requesting a service for each of first servers, a second server for providing for the client devices at least one of a second service history of each of first servers and second service attribution information indicating an attribution of the service provided by each of first servers, in which the at least one client device has a notification request section for requesting the second server to notify at least one of the second service history of each of first servers and the second service attribution information of each of first servers, a server selection section for selecting at least one of the plurality of first servers based on the at least one of the second service history and the second service attribution, which is transmitted from the second server in accordance with the request, and a service request section for requesting a service for the at least one selected first server, and the second server has at least one of a service history generation section for generating the service history and a service attribution information section for generating the service attribution information and a history notification section for notifying the at least one of the generated second service history and the generated second service attribution in response to the notification request from the client device.

### BRIEF DESCRIPTION OF THE DRAWINGS

FIG. 1 is a diagram showing an example information processing apparatus.

FIG. 2 is a diagram showing a first example of the processing performed by the interaction of multiple information processing apparatuses.

FIG. 3 is a diagram showing a second example of the processing performed by the interaction of multiple information processing apparatuses.

FIG. 4 is a diagram showing a third example of the processing performed by the interaction of multiple information processing apparatuses.

FIG. 5 is a diagram showing an example history that is held by a terminal that by which processing is instructed and an apparatus that performs a conversion.

FIG. 6 is a diagram showing an example network system configuration.

FIG. 7 is a diagram showing the hardware arrangement for a scanner in FIG. 6.

FIG. 8 is a diagram showing the hardware arrangement for a printer in FIG. 6.

FIG. 9 is a diagram showing the hardware configuration of a PC 16 in FIG. 6.

FIG. 10 is a diagram showing the structure of a tie-up management program whereby a scanner (FIG. 7) and a printer (FIG. 8) in FIG. 6 provide a service while interacting with another node, and store and manage a history of the services that were provided.

FIG. 11 is a diagram showing an ethernet data frame and an IP packet.

FIG. 12 is a diagram showing the IP header of an IP packet that is transmitted using a payload portion of the ethernet data frame shown in FIG. 11.

FIG. 13 is a diagram showing the hierarchical structure of protocol used for communication between the PC and the printer (FIG. 6).

FIG. 14 is a diagram showing a server selection program whereby the PC in FIG. 6 selects a server based on a service history received from a server, and requests a service.

FIG. 15 is a diagram showing a first example of a user interface image (UI image) that a User interface control section in FIG. 14 displays on a display device (FIG. 9).

FIG. 16 is a diagram showing a second example of the user interface image (UI image) that the User interface control section in FIG. 14 displays on the display device (FIG. 9).

FIG. 17 is a diagram showing a third example of the user interface image (UI image) that the User interface control section in FIG. 14 displays on the display device (FIG. 9).

FIG. 18 is a diagram showing a fourth example of the user interface image (UI image) that the User interface control section in FIG. 14 displays on the display device (FIG. 9).

FIG. 19 is a diagram showing a communication sequence (S10) whereby the PC in FIG. 6 receives service histories from the scanner and the printer.

FIG. 20 is a diagram showing a communication sequence (S12) whereby the PC in FIG. 6 receives a service in a form shown in FIG. 2 from the scanner and the printer.

FIG. 21 is a diagram showing a communication sequence (S14) whereby the PC in FIG. 6 receives a service as a form shown in FIG. 4 from the scanner and the printer.

FIG. 22 is a diagram showing a communication sequence (S20) whereby the PC in FIG. 6 collects service histories from the scanner and the printer and transmits them to the PC.

FIG. 23 is a diagram showing a communication sequence (S22) whereby the PC in FIG. 6 collects service histories from the scanner and the printer and transmits them to the PC′.

FIG. 24 is a diagram showing the structure of a service history notification program executed by a history server in FIG. 6.

FIG. 25 is a diagram showing a communication sequence (S30) whereby the history server in FIG. 6 requests service histories for the scanner and the printer, and transmits the obtained service histories to the PC.

FIG. 26 is a diagram showing a communication sequence (S32) whereby the history server in FIG. 6 prepares a service history by monitoring a packet transmitted via a network, and transmits the service history to the PC and PC′.

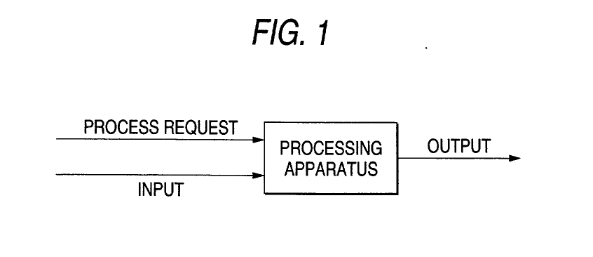

### DETAILED DESCRIPTION OF THE PREFERRED EMBODIMENTS

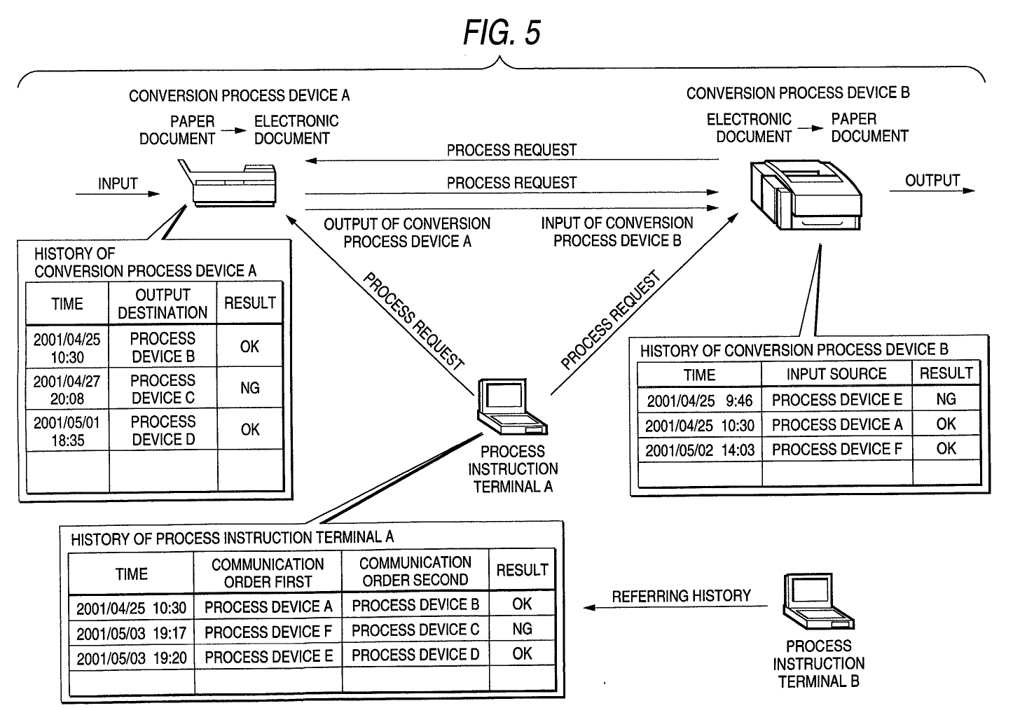

FIG. 5 is a diagram showing example histories held by a terminal that instructs the performance of processing and by an information processing apparatus that performs conversions.

According to the invention, when a variety of types and styles of multiple information processing apparatuses connected to a computer network are employed to preform a cooperation process, as is shown in FIG. 5, a history held by a specific apparatus can be referred to by another apparatus, so that the apparatuses connected to a network can individually select optimal information processing apparatuses.

### First Embodiment

A first embodiment of the present invention will now be described.

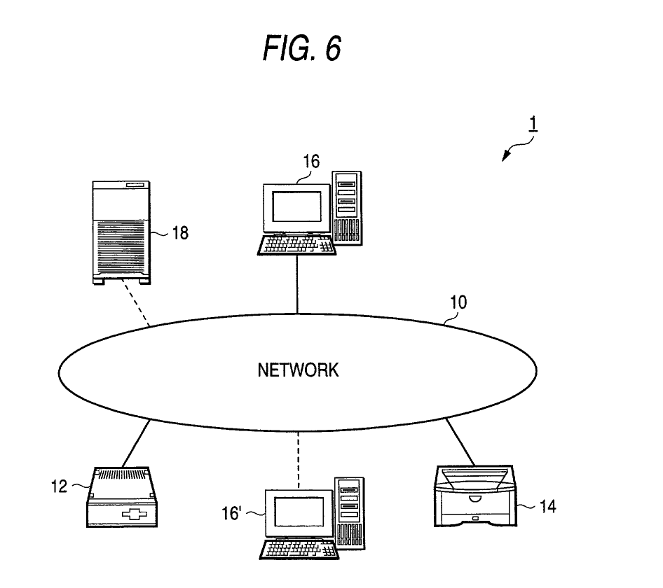

FIG. 6 is a diagram showing a configuration of a network system 1.

As is shown in the network system 1 in FIG. 6, a scanner 12 and a printer 14 that function as servers for providing services are connected to a plurality of personal computers (PCs) 16 and 16′, used as client devices for requesting services for the servers and a history server 18 (which will be described later in a third embodiment) via a network 10, such as an ethernet or TCP/IP.

### Hardware Configuration

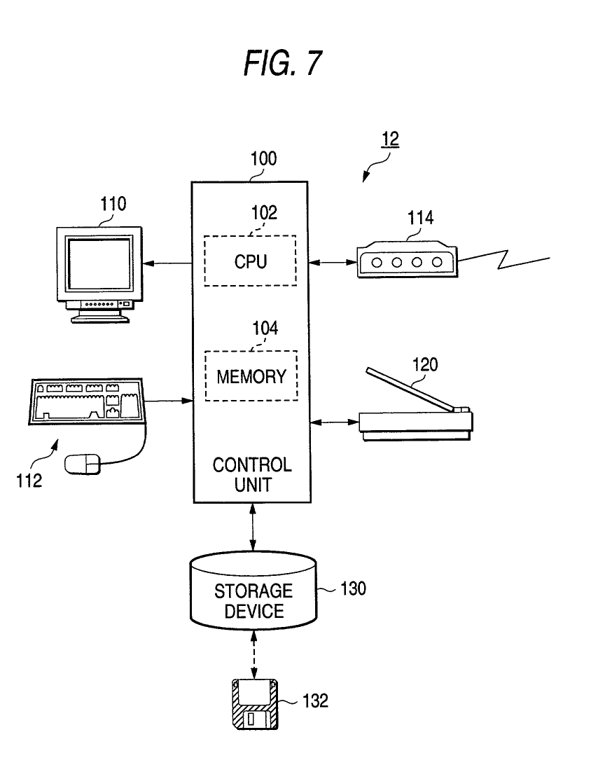

FIG. 7 is a diagram showing the hardware configuration of the scanner 12 in FIG. 6.

As is shown in FIG. 7, the scanner 12 has a control unit 100 including a CPU 102 and a memory 104, a display device 110, such as a CRT, an input device 112 such as a keyboard or a mouse, a communication unit 114 for exchanging data with a network 10, a scanning unit 120 for reading an image to obtain image data, and a storage device 130 such as a CD-ROM or an HDD.

That is, the scanner 12 serves as a network scanner that receives, via the network 10, service requests from the printer 14 and the PC 16 (hereinafter referred to simply as the PC 16 if neither the PC 16 nor the PC 16′ is specifically designated), and that reads an image and transits the image data to the requesting source.

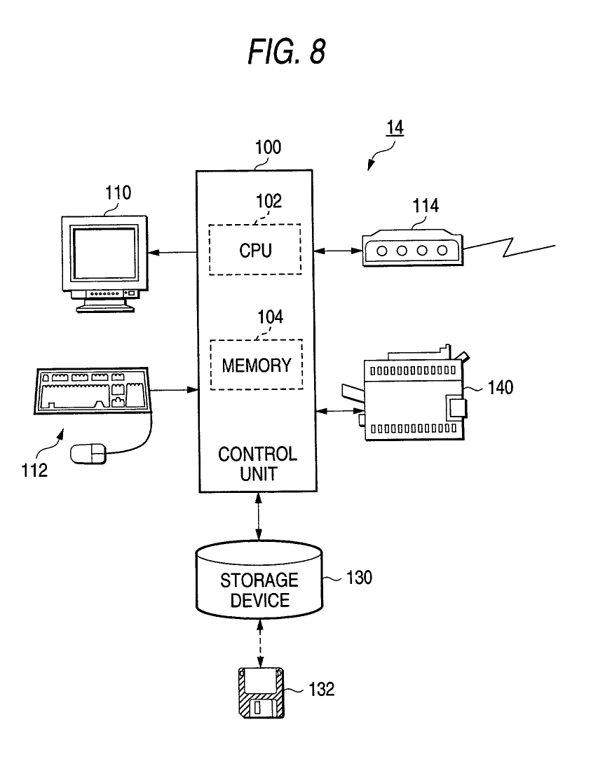

FIG. 8 is a diagram showing the hardware configuration of the printer 14 in FIG. 6.

As is shown in FIG. 8, the printer 14 is designed so as to replace the scanning unit 120 of the scanner 12 with a print section 140.

That is, the printer 14 serves as a network printer that receives, via the network 10, a service request from the PC 16 and prints image data.

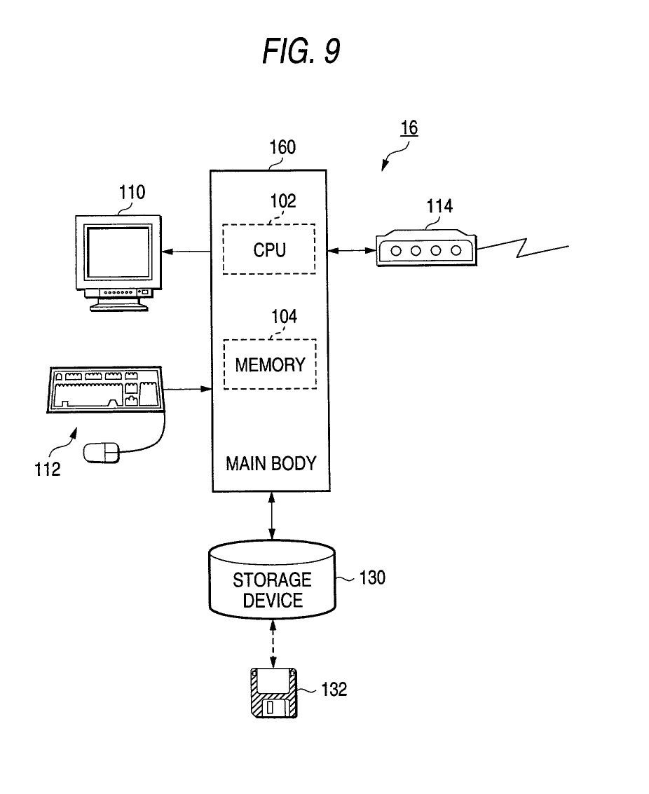

FIG. 9 is a diagram showing the configuration of the PC 16 in FIG. 6.

As is shown in FIG. 9, the PC 16 is designed so that the control unit 100 is replaced with a PC main body 160 and the scanning unit 120 is removed from the scanner 12 (FIG. 7). The PC 16 serves as a general computer that can perform network communication.

The history server 18 also has the same configuration as the PC 16 (not shown).

### Software on Server Side

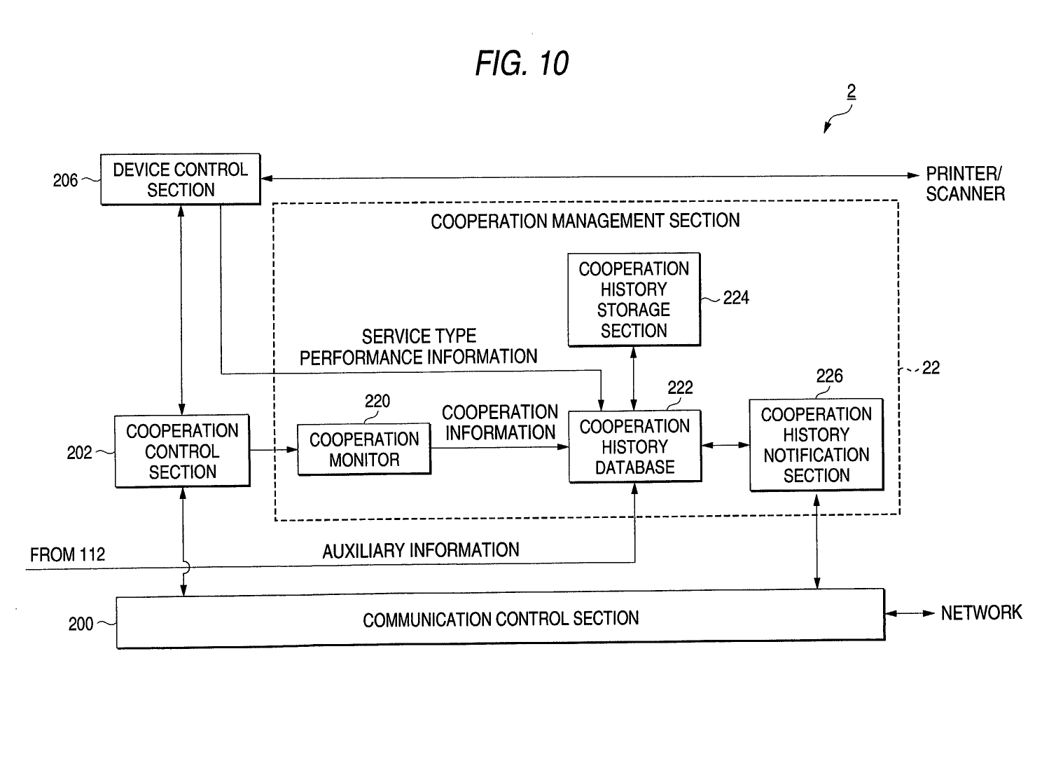

FIG. 10 is a diagram showing the configuration of a cooperation management program 2 by which the scanner 12 (FIG. 7) and the printer 14 (FIG. 8) in FIG. 6 provide a service while interacting with another node, and store or manage a history of the services that were provided

As is shown in FIG. 10, the cooperation management program 2 includes a communication control section 200, a cooperation control section 202, a device control section 206, and a cooperation management section 22.

The cooperation management section 22 includes a cooperation monitor 220, a cooperation history database (a cooperation history DB) 222, a cooperation history storage section 224 and a cooperation history notification section 226.

As is described above, in the scanner 12 and in the printer 14 the cooperation management program 2 is executed and the same functions are implemented. For simplification, an explanation will now be given for a case where in the printer 14, the cooperation management program 2 is executed.

The cooperation management program 2 is transmitted, via a recording medium 132, to the printer 14 and is loaded into the memory 102 and executed (FIG. 8).

The cooperation management program 2 employs the components shown in FIG. 10 to store a history (a service history) of the services that the printer 14 independently provided for the PC 16, and a history of the services that the printer 14 provided for the PC 16 while interacting with the scanner 12.

In response to a request from the PC 16, the cooperation management program 2 transmits the service histories, which is stored/managed by the cooperation management program 2, to the PC 16.

### Communication Control Section 200

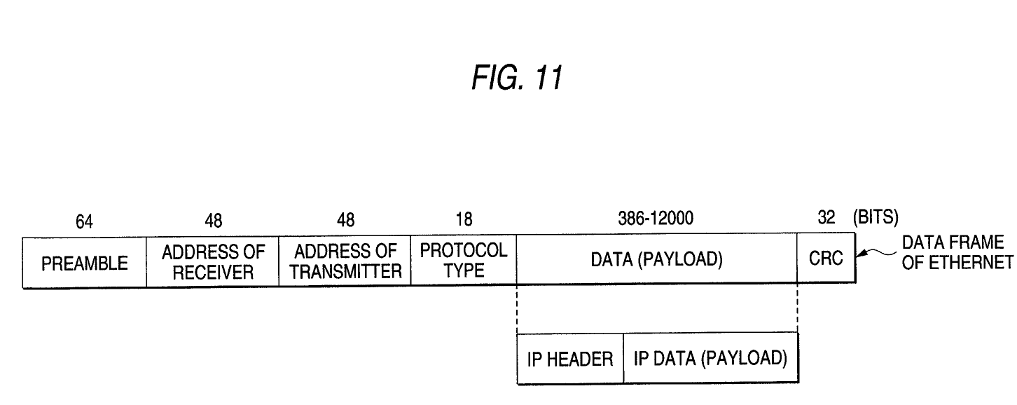

FIG. 11 is a diagram showing an ethernet data frame and an IP packet.

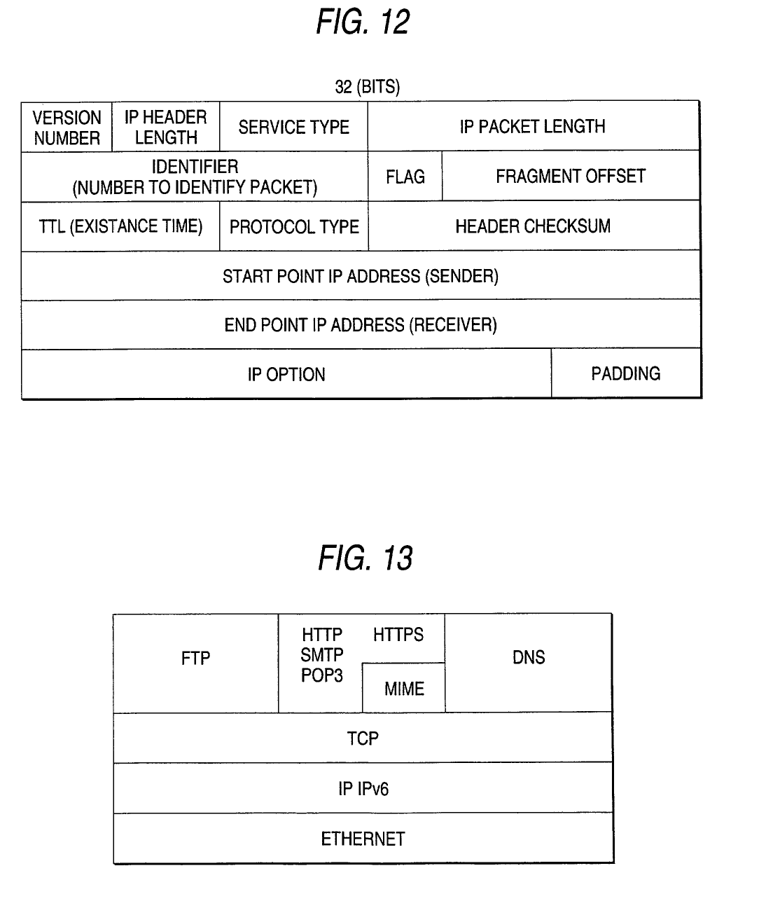

FIG. 12 is a diagram showing the IP header of an IP packet that is transmitted by using the payload portion of the ethernet data frame shown in FIG. 11.

The communication control section 200 (FIG. 10) controls the communication unit 114 to communicate with other nodes (the scanner 12, the PCs 16 and 16′ and the history server 18) via the network 10.

The communication control section 200 transmits to another node data that is entered by the other components of the cooperation management program 2, or receives data from the other nodes via the network 10, and outputs the data to the other components of the cooperation management program 2.

The ethernet data frame in FIG. 11 is employed to exchang data between the printer 14 and other nodes. The IP packet in FIG. 11 is attached to the data, which is incorporated into the payload portion of the ethernet data frame for transmission.

### Cooperation Control Section 202

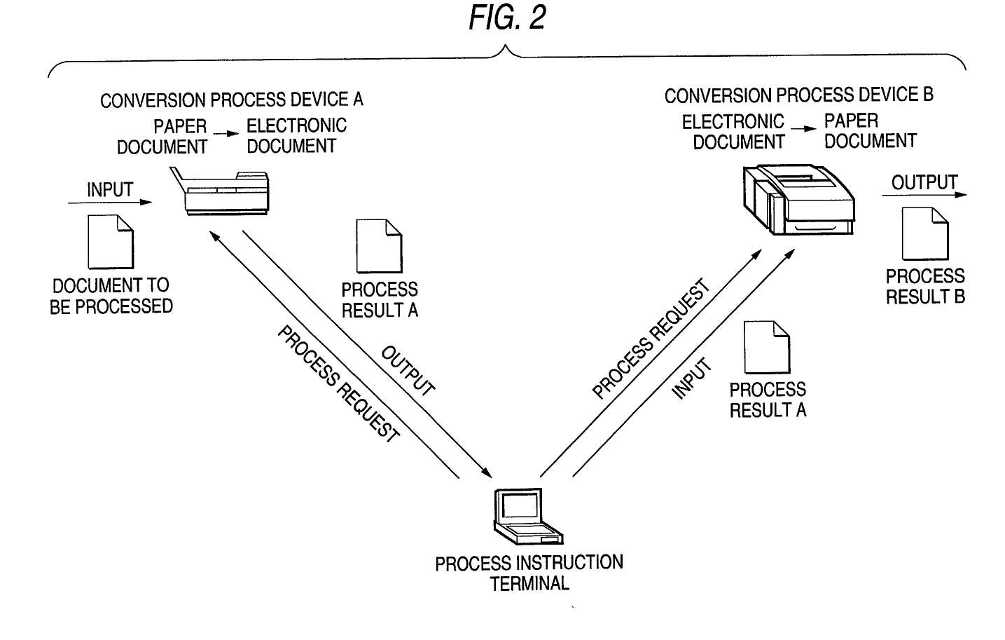

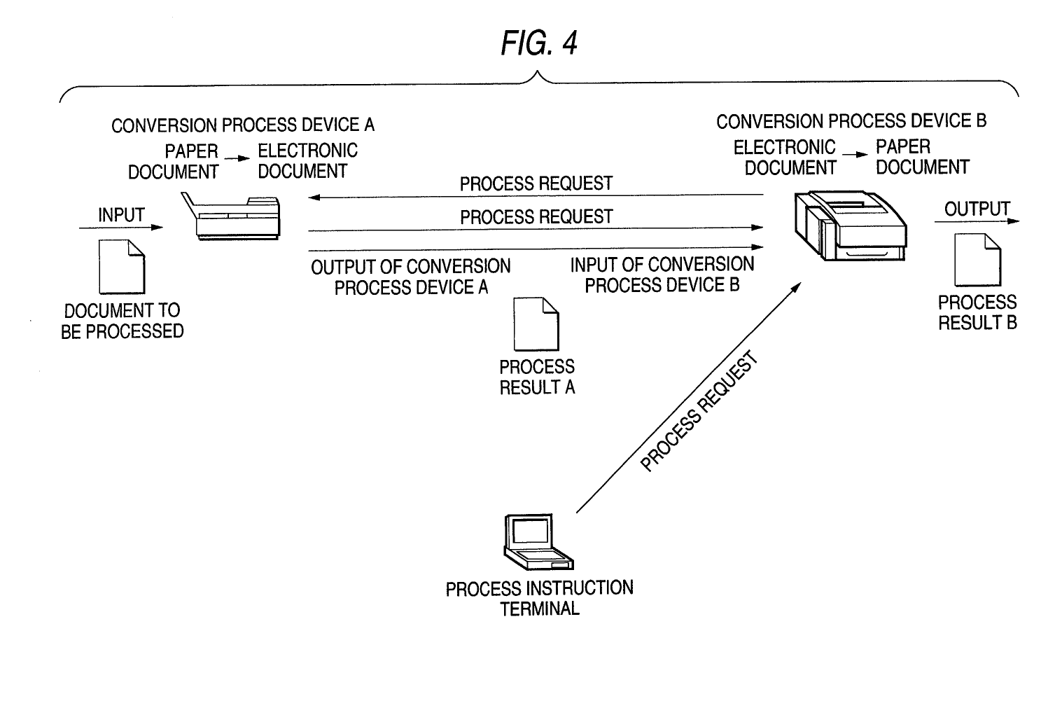

Upon receiving a service request from the PC 16, the cooperation control section 202 (FIG. 10) performs the processing for interacting with other nodes in the various forms shown in FIGS. 2 and 4.

As is shown in FIG. 2, the cooperation control section 202 interacts with the PC 16 in order to print image data received from the PC 16.

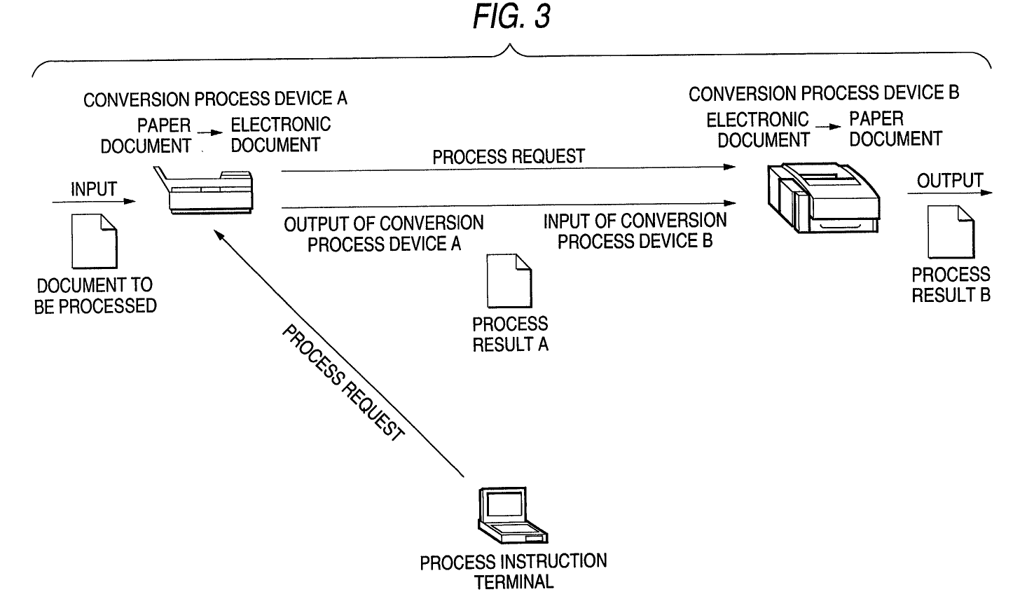

Further, as is shown in FIG. 3, when the PC 16 requests a service for the scanner 12, and the scanner 12 forwards a printing request to the printer 14, all component interaction is controlled by the cooperation control section 202.

As is shown in FIG. 4, when the PC 16 requests a service for the printer 14, and when the printer 14 requests that the scanner 12 to read images, the interaction between the scanner 12 and the PC 16 is controlled by the cooperation control section 202.

### Device Control Section 206

In accordance with the control of the cooperation control section 202, the device control section 206 controls the print unit 140 to print image data received from the PC 16 or the scanner 12, and thus provides a print service.

### Cooperation Monitor 220

The cooperation monitor 220 monitors data to be processed by the cooperation control section 202, displays a service that the printer 15 has provided by interacting with another node, generates the following cooperation information including cooperation destination information, setup information, and normality/abnormality end information, and outputs the cooperation information to the cooperation history DB 222.

That is, the cooperation history DB 222 refers a “start point IP address” and an “end IP address”, which are included in the IP header (FIG. 12) of data that are exchanged with another node and are processed by the cooperation control section 202 to detect which nodes the printer unit 14 is in cooperate with to provide service (cooperation destination information).

Further, the cooperation history DB 222 detects setup (setup information) that the cooperation control section 202 performs for the device control section 206.

In addition, the cooperation histroy DB 222 detects whether the cooperation control section 202 has provided a service normally (normality/abnormality end information).

### Cooperation History DB 222

The cooperation history DB 222 stores the cooperation information sequentially input from the cooperation monitor 220 in the cooperation history storage section 224.

Further, the cooperation history DB 222 stores a service type, for example, indicating the apparatus 14 is a printer, performance information of the printer 14 such as the printing speed (ppm) of a print section 140 set in the device control section 206, printing density, information indicating whether color printing is available, and protocols (Ipd), and auxiliary information, which is set by the display device 110 and indicates user limitations, an installation site (a place whereat the printer 14 is located), and the user who installed the printer 14 in the cooperation history storage section 224.

The auxiliary information includes server performance (printing speed, printing density, compatible protocols, compatible color printing, available document sizes (A3, A4, letter size and postcard size), compatible document (PS or ART), output tray information, presence/absence of a sorter, presence/absence of a stapling device, presence/absence of a punching device, presence/absence of a document device (enlargement/reduction, mirror image conversion, negative/positive conversion, N-up (printing of multiple pages on a single sheet), page direction, and presence/absence of an automatic document feeder), a using user (a user ID), user limitation information (use inhibitions imposed on part of the users), an installation site (physical installation location); the user who installed the apparatus (the user ID of the user who installed the apparatus), a use frequency (how many times a service was used, how many times which function was used and which users employed the service), an employment time; information indicating data to be processed (data to be processed, and whether processed data is color data), the time required for a service, and the number of results obtained through the service.

The cooperation history DB 222 adds the frequency of employment of the printer 14 and the time required to provide the service to the cooperation information, the service type, the performance information and the auxiliary information that are stored in the cooperation history storage section 224 to generate a service history.

The service history includes, as the minimum required elements, the network address of both or either of a client device and a server that provided a service, as well as the service type (the printing service, the scanning service or the facsimile service) and the service results as necessary information.

Furthermore, in response to a request from the cooperation history notification section 226, the cooperation history DB 222 outputs the generated service history to the cooperation history notification section 226.

### Cooperation History Notification Section 226

FIG. 13 is a diagram showing the hierarchical structure of a protocol that is used for communication between the PC 16 and the printer 14 in FIG. 6.

In response to a history request from the PC 16 via the network 10, the cooperation history notification section 226 outputs, to the PC 16, the service history input from the cooperation history DB 222.

For communication between the PC 16 and the printer 14, the FTP protocol or the HTTP•HTTPS protocol shown in FIG. 13 is employed.

### Software on the Client Side

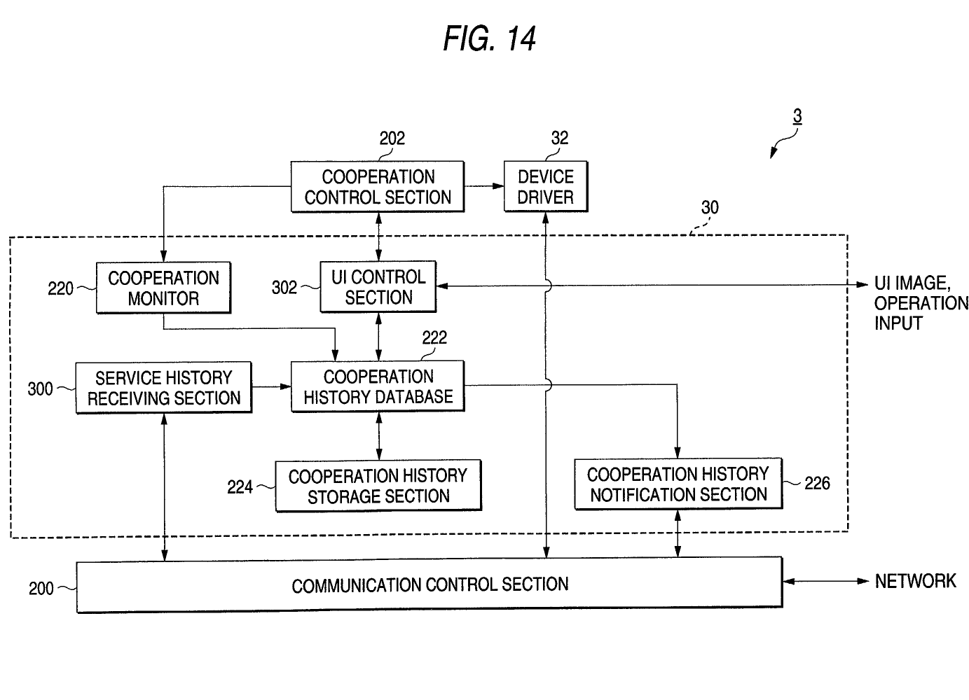

FIG. 14 is a diagram showing the structure of a server selection program 3 that selects a server based on the service history received from the server to request a service.

As is shown in FIG. 14, the server selection program 3 includes a communication control section 200 and a cooperation control section 202, a device driver 32 and a cooperation management section 30.

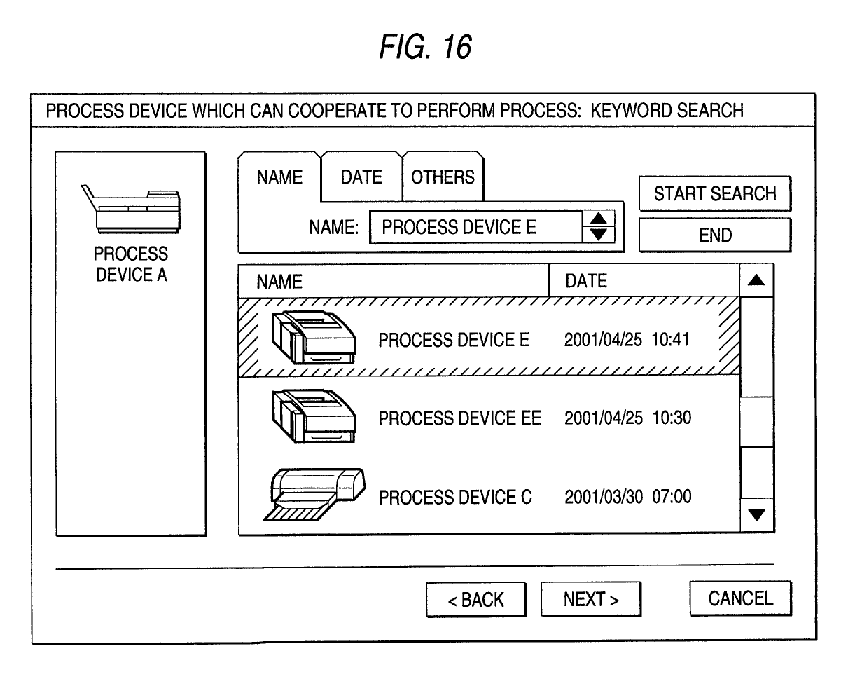

As with the cooperation management program 2 (FIG. 10), the server selection program 3 is provided by the storage medium 132, is provided to the PCs 16 and 16′, and is loaded into the memory 104 (FIG. 16).

The cooperation management section 30 includes the cooperation monitor 220, the cooperation history DB 222, the cooperation history storage section 224, the cooperation history notification section 226, a service history receiving section 300 and a user interface control section 302.

The same reference numerals used for the cooperation management program 2 in FIG. 10 are also used to denote corresponding components of the server selection program 3.

### Device Driver 32

In accordance with the control of the cooperation control section 202, the device driver 32 communicates with the scanner 12 and the printer 14 to make the scanner 12 and the printer 14 execute a service.

### Service History Receiving Section 300

The service history receiving section 300 requests service histories for each of the scanner 12 and the printer 14, and receives the requested service histories in response to the request. Then, the service history receiving section 300 outputs the service histories to the cooperation history DB 222.

### User Interface Control Section 302

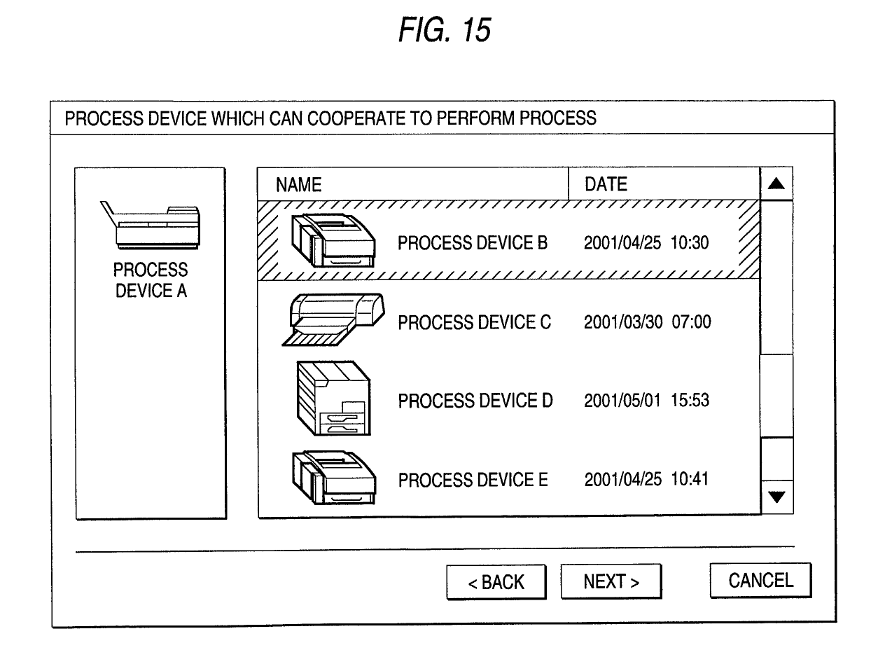

FIGS. 15 to 18 are first to fourth diagrams showing a user interface image (UI image) that the User interface control section 302 shown in FIG. 14 displays on the display device 110 (FIG. 9).

The User interface control section 302 displays, for the user, the contents of the service history from the service history managed in the cooperation history DB 222, generates a UI image employed for the user's operation, and displays the UI image on the display device 110 (FIG. 9).

That is, the User interface control section 302 receives a service history from the cooperation history DB 222, and generates and displays the first UI image (FIG. 15) that represents a list of servers, which is available in cooperation.

Further, the User interface control section 302 generates second UI image (FIG. 16) used for a keyword search of a server, and displays the second UI image on the display device 110.

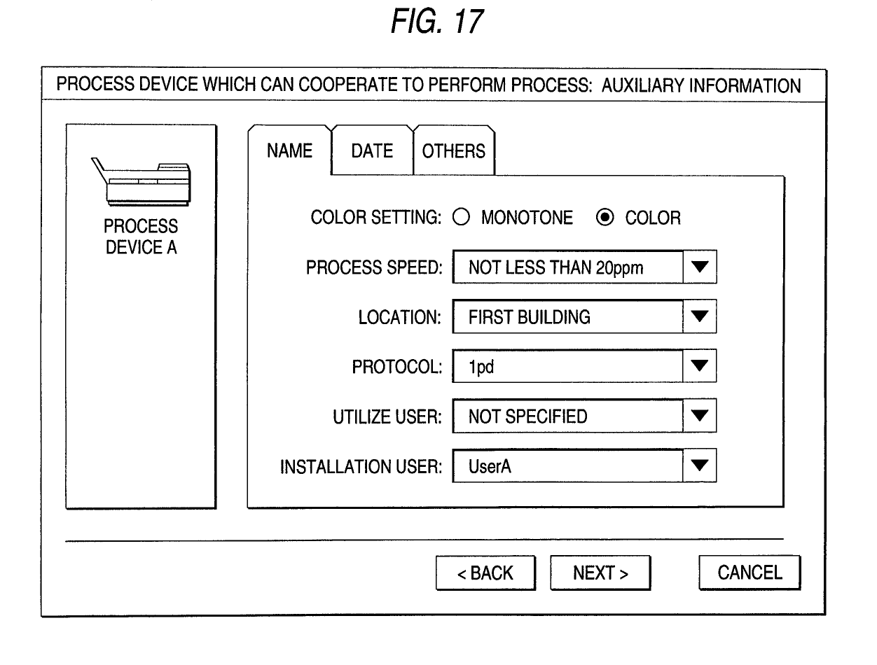

Furthermore, the User interface control section 302 generates third UI image (FIG. 17), which represents the auxiliary information for a server that is selected by the user's selecting operation for the UI image shown in FIG. 15 or 16, and displays the third UI image on the display device 110.

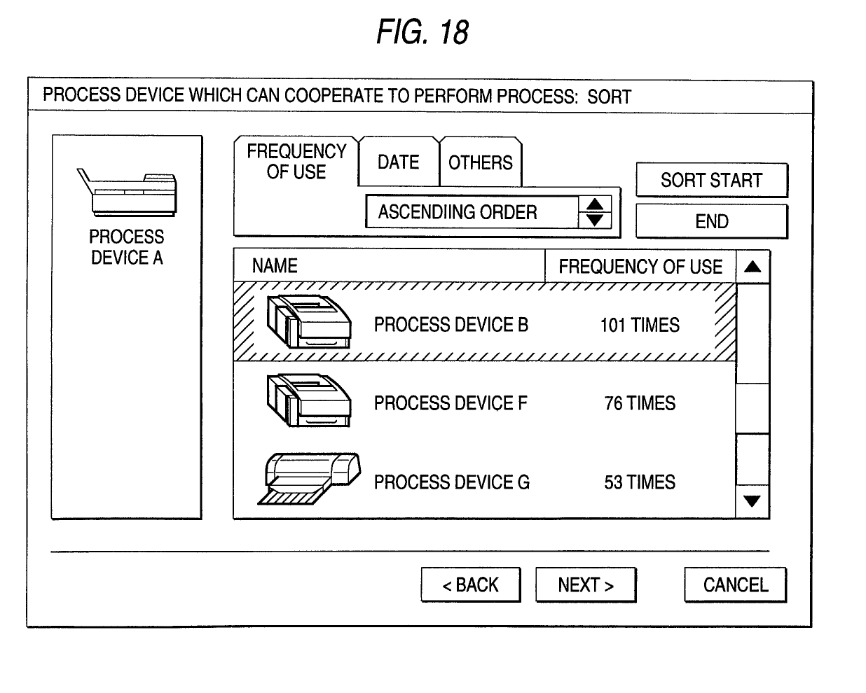

In addition, the User interface control section 302 sorts the service histories using a common sorting algorithm, generates fourth UI image (FIG. 18) representing the sorted servers, and displays the fourth UI image on the display device 110.

Moreover, upon the User interface control section 302 receives the operation by a user for the displayed UI image, selects a server to which a service is requested (both or either of the scanner 12 and the printer 14), and sets the selected server in the cooperation control section 202.

### Operation of the Network System 1

The operations of the scanner 12, the printer 14 and the PC 16 in the network system 1 will now be described.

At the printer 14 and the scanner 12 (the cooperation management program 2 in FIG. 10), when the cooperation control section 202 receives a service request from the PC 16 and cooperate with another monitor to provide a service, the cooperation monitor 220 monitors the cooperation control section 202 and outputs the cooperation information to the cooperation history DB 222.

The cooperation history DB 222 of the cooperation management program 2 stores in the cooperation history storage section 224, the cooperation information input from the cooperation monitor 220, the service type and the performance information input from the device control section 206, and the auxiliary information input from the input device 112 (FIGS. 7 and 8) to generate the service history from these stored information.

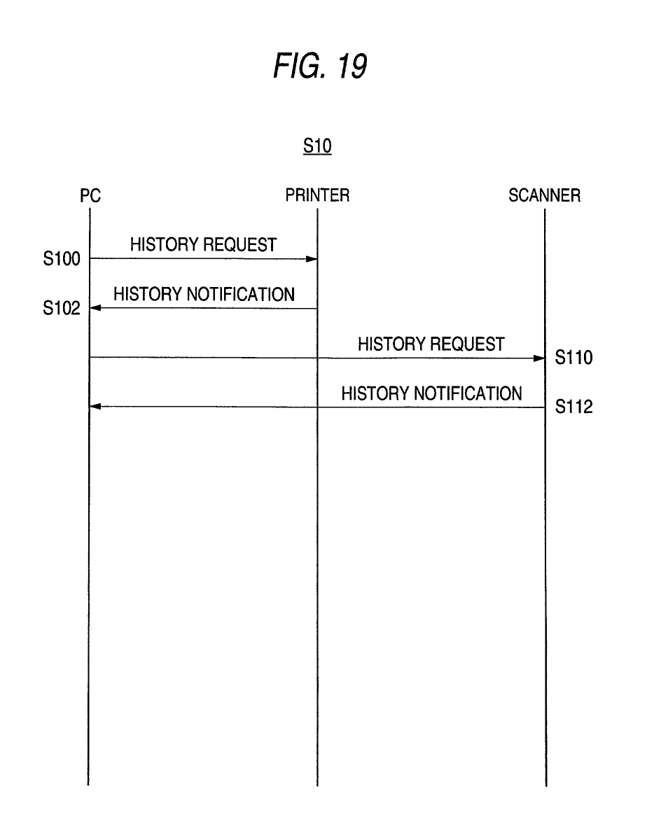

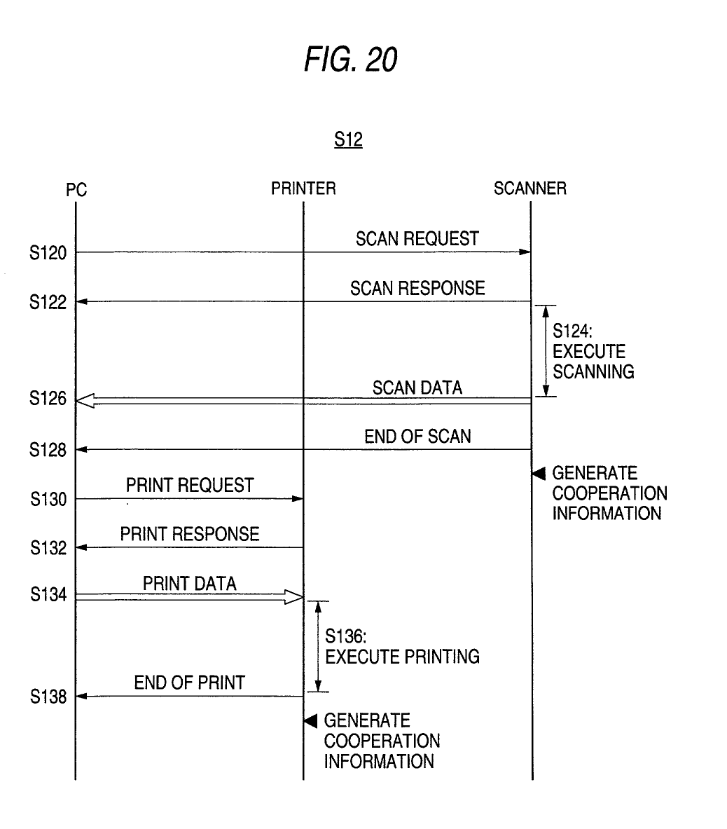

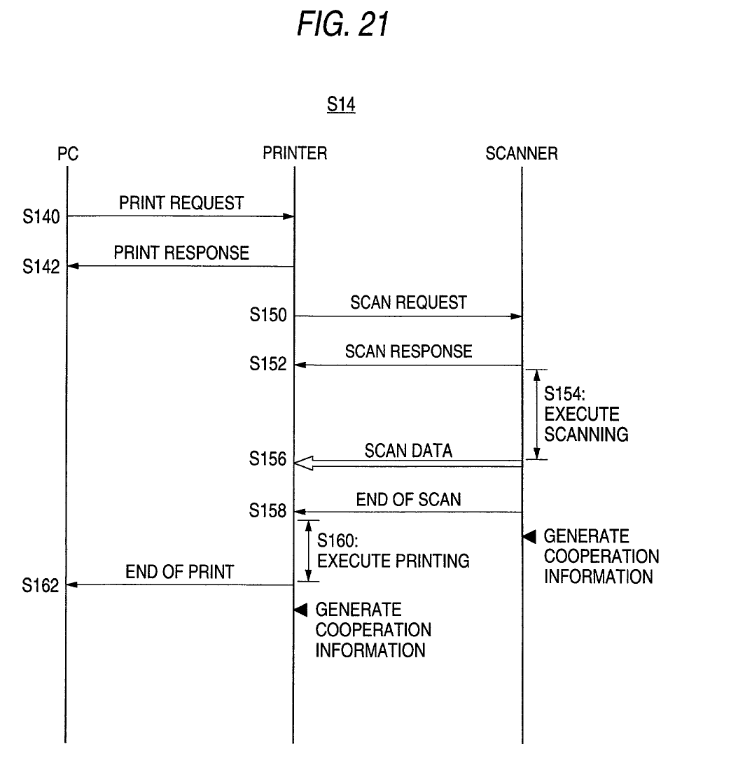

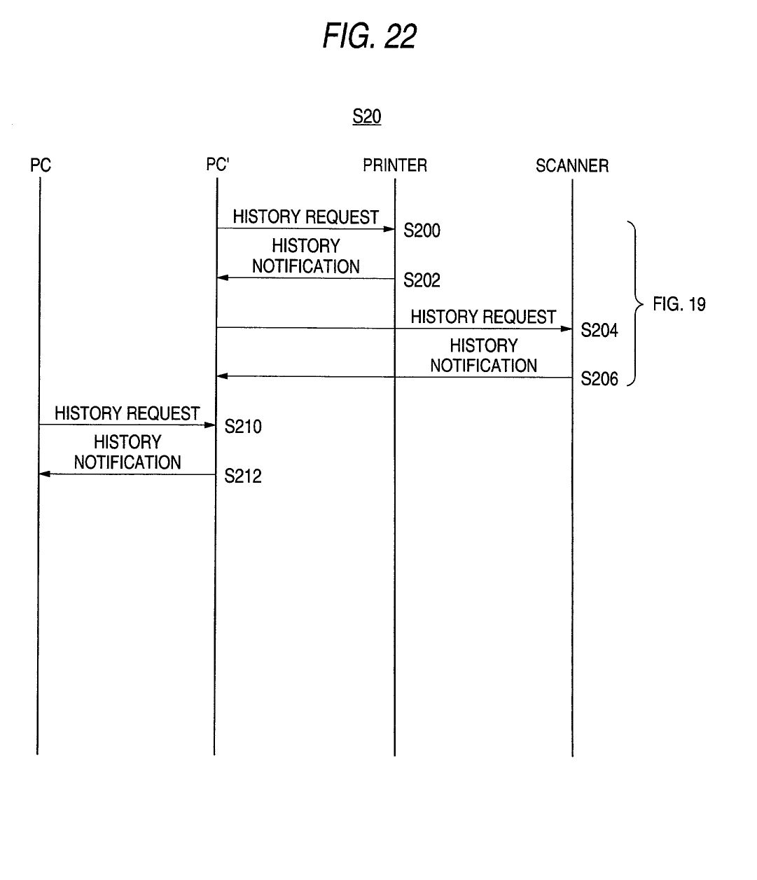

FIG. 19 is a diagram showing a communication sequence (S10) in which the PC 16 in FIG. 6 receives service histories from each of the scanner 12 and the printer 14.

As is shown in FIG. 19, the service history receiving section 300 of the PC 16 (the server selection program 3 in FIG. 14) requests a service history for the printer 14 (S100)

Upon receiving this request, the cooperation history notification section 226 of the printer 14 (cooperation management program 2 in FIG. 10) reads a service history from the cooperation history DB 222 and transmits the read service history to the PC 16 (S102)

Similarly, the service history receiving section 300 of the PC 16 (the server selection program 3 in FIG. 14) requests a service history for the scanner 12 (Silo).

Upon receiving this request, the cooperation history notification section 226 of the scanner 12 (the cooperation management program 2 in FIG. 10) reads a service history from the cooperation history DB 222, and transmits the read service history to the PC 16 (S112).

The service history receiving section 300 of the PC 16 (the server selection program 3 in FIG. 14) receiving the service history from the scanner 12 and the printer 14 with the above described communication outputs the received service history to the cooperation history DB 222.

The cooperation history DB 222 of the PC 16 (the server selection program 3) stores and manages the input service history in the cooperation history storage section 224.

When the user of the PC 16 employs the service provided by the server, the User interface control section 302 (FIG. 14) of the PC 16 displays, on the display device 110 (FIG. 9), the UI image, which is exemplified in FIGS. 15 to 18.

When the user performs selection operation on a UI image displayed by the User interface control section 302, the User interface control section 302 selects the scanner 12 and the printer 14 as servers in accordance with this operation and sets the scanner 12 and the printer 14 in the cooperation control section 202.

First, an explanation will be given on a form shown in FIG. 2 in which the PC 16, the scanner 12 and the printer 14 cooperate to perform printing process.

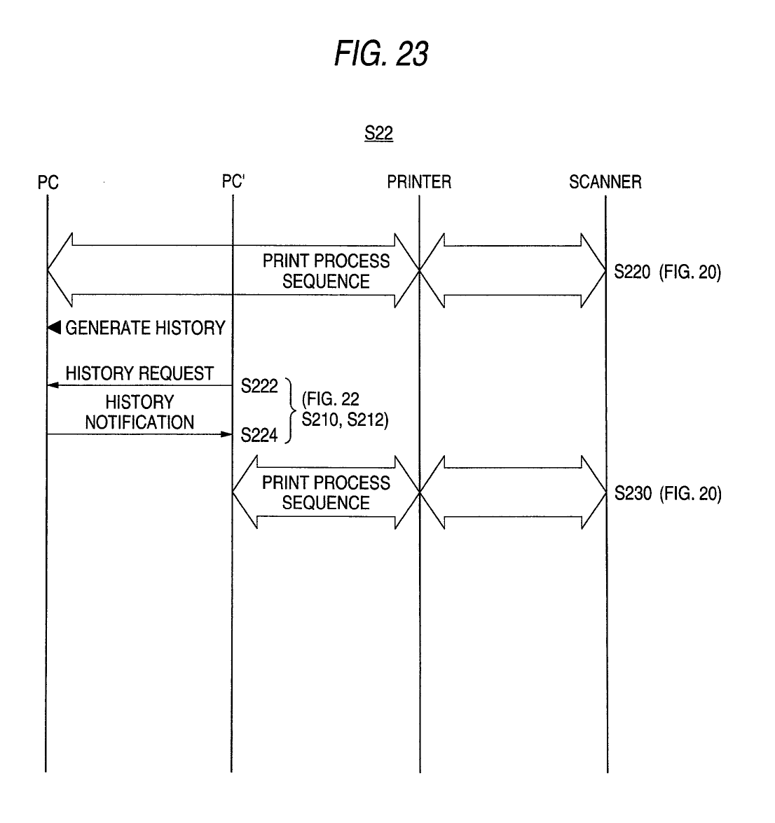

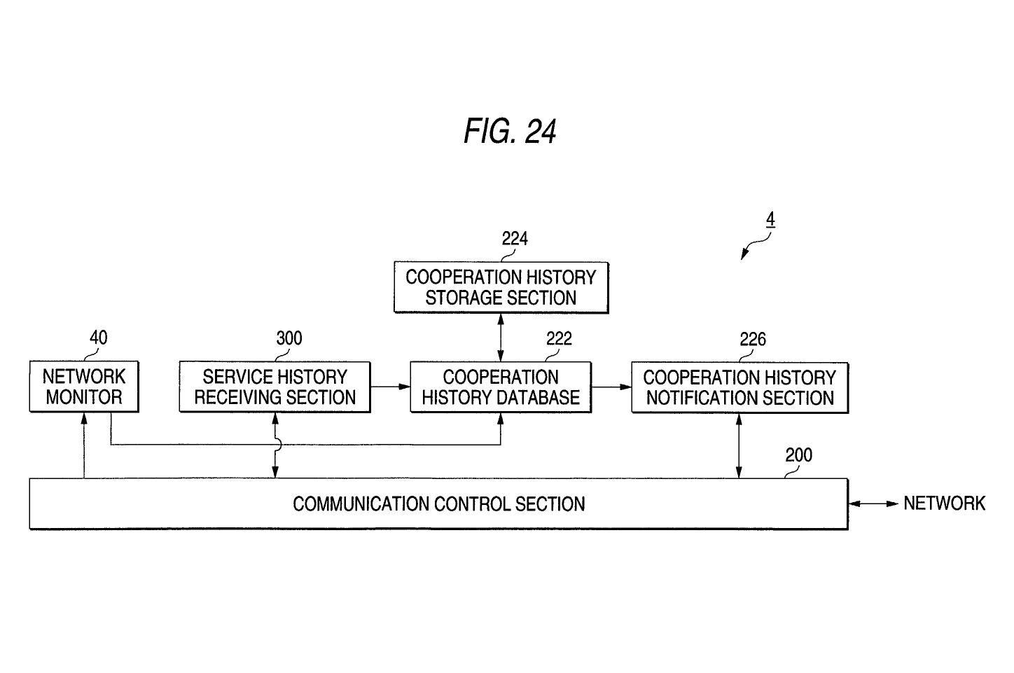

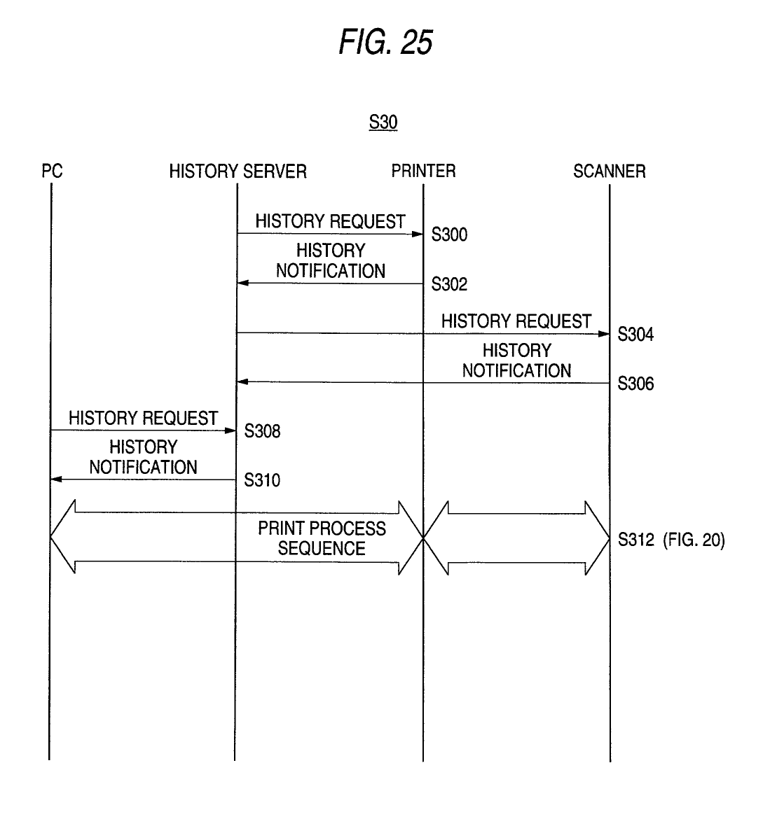

FIG. 20 is a diagram showing the communication sequence (S12) in which the PC 16 in FIG. 6 receives a service in the form shown in FIG. 2 from the scanner 12 and the printer 14.

As is shown in FIG. 20, in the PC 16 (the server selection program 3 in FIG. 14), in accordance with the setting from the User Interface control section 302, the cooperation control section 202 requests the scanner 12 to perform an image scan (S120).

The cooperation control section 202 of the scanner 12 (the cooperation management program 2 in FIG. 10) transmits to the PC 16 a response indicating image scanning start (S122), controls the scanning unit 120 (FIG. 7) via the device control section 206, and makes the scanning unit to execute the image scanning (S124)

When the image scanning is completed, the cooperation control section 202 of the scanner 12 (the cooperation management program 2 in FIG. 10) transmits to the PC 16 image data (scan data) obtained from the device control section 206 as a result of scanning (S126).

When the transmission of scan data has been completed, the cooperation control section 202 of the scanner 12 (the cooperation management program 2 in FIG. 10) notifies end of scanning to the PC 16 (S128).

The cooperation control section 202 of the PC 16 (server selection program 3 in FIG. 14) then requests the printer 14 to perform printing (S130).

When, upon receiving the request, the cooperation control section 202 of the printer 14 (the cooperation management program 2 in FIG. 10) transmits print response indicating that printing is available, the cooperation control section 202 of the PC 16 (the server selection program 3 in FIG. 14) transmits to the printer 14 the received scan data as print data (S134).

Upon receiving the print data, the cooperation control section 202 of the printer 14 (the cooperation management program 2 in FIG. 10) controls the printer 14, via the device control section 206, and makes the printer 14 to print the received print data (S136).

When the printing has been completed, the cooperation control section 202 of the printer 14 (the cooperation management program 2 in FIG. 10) notifies an end of the printing to the PC 16 (S138).

In the scanner 12 and the printer 14 (the cooperation management program 2 in FIG. 10), the cooperation monitor 220 monitors the above described operation of the cooperation control section 202 and transmits to the cooperation history DB 222 the cooperation information with the PC 16 that is obtained as a result of the monitoring. The cooperation history DB 222 stores and manages the input cooperation information in the cooperation history storage section 224.

Next, an explanation will now be given on a form shown in FIG. 4 in which the PC 16, the scanner 12 and the printer 14 cooperate to perform the printing process.

FIG. 21 is a diagram showing a communication sequence (S14) whereby the PC 16 in FIG. 6 receives a 28 service from the scanner 12 and the printer 14 having the form shown in FIG. 4.

As is shown in FIG. 21, in the PC 16 (the server selection program 3 in FIG. 14), in accordance with the setting from the User Interface control section 302, the cooperation control section 202 specifies the scanner 12 to the printer 14 to request printing scan data generated by the scanner 12 (S140).

The cooperation control section 202 of the printer 14 (the cooperation management program 2 in FIG. 10) transmits print response indicating printing start to the PC 16 (S142), and requests that the scanner 12 to perform the scanning (S150).

Upon receiving the scanning request, the cooperation control section 202 of the scanner 12 (the cooperation management program 2 in FIG. 10) transmits to the PC 16 a scan response indicating the scanning start (S152), and controls the scanning unit 120 (FIG. 7) via the device control section 206 to make the scanning unit 120 to execute the scanning (S154).

When the scanning has been completed, the cooperation control section 202 of the scanner 12 (the cooperation management program 2 in FIG. 10) transmits scan data to the print section 140 (S156). When the transmission has been completed, the cooperation control section 202 of the scanner 12 notifies end of the scanning to the printer 14 (S158).

Upon receiving the notification of the end of the scanning, the cooperation control section 202 of the printer 14 (the cooperation management program 2 in FIG. 10) controls the print section 140 (FIG. 8) via the device control section 206 and makes the print section execute the printing (S160).

When the printing has been completed, the cooperation control section 202 of the printer 14 (the cooperation management program 2) notifies end of the printing to the PC 16 (S162).

In the scanner 12 and the printer 14 (the cooperation management program 2 in FIG. 10), the cooperation monitor 220 monitors the operation of the cooperation control section 202, and outputs to the cooperation history DB 222 the cooperation information with the PC 16 that is obtained as a result of the monitoring. The cooperation history DB 222 stores and manages the input cooperation information in the cooperation history storage section 224.

### Modification Example

The cooperation monitor 220 may detect, from the cooperation control section 202, other information such as information (a user ID) concerning a person who requested a service, information (image data or whether image data is color or monotone) concerning data to be processed, the time (time information) required for the provision of a service, and the number of objects (the number of printed copies) obtained as a result of the performance of the service. The cooperation history DB 222 may store and manage these data.

The IP address is employed as information indicating cooperation destination of the scanner 12 and the printer 14, which are managed by the cooperation history DB 222. However, for example, MAC address or URL may be used in place of the IP address.

### Second Embodiment

As a second embodiment of the invention, an explanation will be given on a method in which the PC′ 16′ in FIG. 6 collects service histories and transmits the service histories to the PC 16.

FIG. 22 is a diagram showing a communication sequence (S20) in which the PC′ 16′ in FIG. 6 collects service histories from the scanner 12 and the printer 14 and transmits the service histories to the PC 16.

As is shown in FIG. 22, when the PC′ 16′ requests the service history for the printer 14 (S200), the printer 14 transmits the service history to the PC′ 16′ in response to the request (S202).

Similarly, when the PC′ 16′ requests the service history for the scanner 12 (S204), the scanner 12 transmits the service history to the PC′ 16′ in response to the request (S206).

This communication sequence is the same as that for the PC 16 shown in FIG. 19.

When the service history receiving section 300 of the PC 16 (the server selection program 3 in FIG. 14) requests a service history for the PC′ 16′ (S210), the cooperation history notification section 226 of the PC′ 16′ (the server selection program 3) reads the service history from the cooperation history DB 222 in accordance with the request and transmits the read service history for/to the PC 16 (S212).

FIG. 23 is a diagram showing a communication sequence (S22) in which the PC 16 in FIG. 6 collects a history for services provided by the scanner 12 and the printer 14 and transmits the service history to the PC′ 16′.

As is shown in FIG. 23, the PC 16 performs the print process sequence with the scanner 12 and the printer 14 (S220).

The “print process sequence” may include the communication sequences shown in FIGS. 20 and 21. However, the print process sequence is not limited to these.

The communication sequence at S220 is the same as that in FIG. 20.

In the communication sequence at S220, the cooperation monitor 220 of the PC 16 (the server selection program 3 in FIG. 14) monitors the process performed by the cooperation control section 202, generates cooperation information, and outputs the cooperation information to the cooperation history DB 222.

The cooperation history DB 222 of the PC 16 (the server selection program 3) generates a service history by using the cooperation information input from the cooperation monitor 220, and stores and manages the service history in the cooperation history storage section 224.

When the service history receiving section 300 of the PC 16 (the server selection program 3 in FIG. 14) requests the service history for the PC′ 16′ (S222), the cooperation history notification section 226 of the PC′ 16′ (the server selection program 3) reads the service history from the cooperation history DB 222 in accordance with the request and transmits the read service history for/to the PC 16 (S224).

It should be noted that the communication sequence performed by the PC 16 and the PC′ 16′ is the same as the sequences at S210 and S212 in FIG. 22.

The PC′ 16′ thus obtaining the service history from the PC 16 execute, for example, the communication sequence shown in FIG. 20 with the scanner 12 and the printer 14 to perform printing the data.

### Third Embodiment

As a third embodiment of the invention, an explanation will now be given on a method in which the history server 18 in FIG. 6 generates a service history and transmits the service history to the PC 16 and the PC′ 16′.

FIG. 24 is a diagram showing configuration of service history notification program 4 that is executed by the history server 18 in FIG. 6.

As is shown in FIG. 24, the service history notification program 4 includes the service history receiving section 300, the cooperation history DB 222, the cooperation history storage section 224, the cooperation history notification section 226 and a network monitor 40.

As with the cooperation management program 2 (FIG. 10) and the server selection program 3 (FIG. 14), the service history notification program 4 is supplied by the recording medium 132 to the history server 18, which has the same arrangement as the PC 16 (FIG. 9), and is loaded into the memory 104 for execution.

It should be noted that the same reference numerals as used for the cooperation management program 2 (FIG. 10) and the server selection program 3 (FIG. 14) are also used to denote corresponding components of the service history notification program 4 in FIG. 24.

### Network Monitor 40

The network monitor 40 monitors an IP packet that is transmitted through the communication control section 200 to the network 10 and extracts packets relating to a process which the PC 16, 16′, the scanner 12, and the printer 14 cooperate to perform from the IP packet transmitted to the network 10.

Further, the network monitor 40 generates the cooperation information and the auxiliary information from the extracted packets. Furthermore, the network monitor 40 generates the service history from the generated cooperation history and the generated auxiliary information and outputs the service history to the cooperation history DB 222.

That is, the network monitor 40 has a function for monitoring the network 10, a function for serving as the cooperation monitor 220 and a function for generating the service history.

First, an explanation will be given on a case where the history server 18 in FIG. 6 requests service histories for the scanner 12 and the printer 14 and transmits to the PC 16 the service histories transmitted from the scanner 12 and the printer 14 in response to the request.

FIG. 25 is a diagram showing a communication sequence (S30) in which the history server 18 in FIG. 6 requests a service history for the scanner 12 and the printer 14 and transmits the service histories obtained in response to the request to the PC 16.

The service history receiving section 300 of the history server 18 (the service history notification program 4 in FIG. 24) requests a service history for the printer 14 (S300) and receives the service history from the printer 14 in response to the request (S302).

Similarly, the service history receiving section 300 of the history server 18 (the service history notification program 4) requests a service history for the scanner 12 (S304), and receives the service history from the scanner 12 in response to the request (S306).

The service history receiving section 300 then outputs these service histories to the cooperation history DB 222. The cooperation history DB 222 stores and manages the service histories in the cooperation history storage section 224.

When the service history receiving section 300 of the PC 16 (the server selection program 3 in FIG. 14) requests a service history for the history server 18, the cooperation history notification section 226 of the history server 18 (the service history notification program 4 in FIG. 24) reads the service history from the cooperation history DB 222 and transmits the read service history to the PC 16 (S310).

The PC 16 employs the service history received from the history server 18, for example, to perform the communication sequence for the print process with the scanner 12 and the printer 14.

An explanation will now be given on a case where the history server 18 in FIG. 6 monitors IP packet transmitted to the network 10 to generate service history and transmits the service history to the PC 16 and the PC′ 16′.

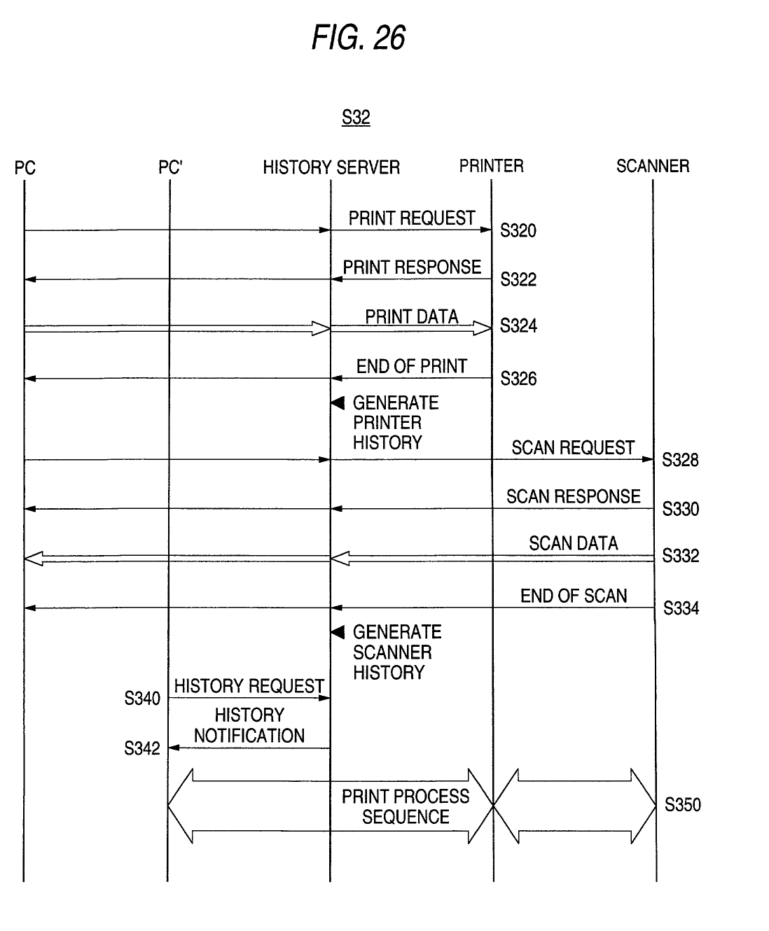

FIG. 26 is a diagram showing a communication sequence (S32) in which the history server 18 in FIG. 6 monitors the IP packet transmitted to the network 10 to generate a service history and transmits the service history to the PC 16 and the PC′ 16′.

The PC 16 (FIG. 6) requests that the printer 14 to perform printing (S320), the printer 14 transmits a print response in response to the request (S322), the PC 16 transmits the print data to the printer 14 (S324), and the printer 14 notifies end of printing to the PC 16 (S326).

The PC 16 requests the scanner 12 to scan images (S328), the scanner 12 transmits to the PC 16 a scan response in response to the request (S330), the scanner 12 transmits scan data to the PC 16 (S332), and the scanner 12 notifies end of the scanning to the PC 16 (S334).

The network monitor 40 of the history server 18 (the service history notification program 4 in FIG. 24) monitors the IP packets transmitted to the network 10, generates a service history, and outputs the generated service history to the cooperation history DB 222.

The cooperation history DB 222 stores and manages the service history input from the network monitor 40 in the cooperation history storage section 224.

When the PC′ 16′ requests for the history server 18 a service history (S340), the cooperation history notification section 226 of the history server 18 (the service history notification program 4 in FIG. 24) reads the service history from the cooperation history DB 222 in response to the request and transits the read service history to the PC′ 16′ (S342).

The PC′ 16′ employs the service history received from the history server 18, for example, to perform the communication shown in FIG. 20 so as to perform print process (S350).

As described above, it has been described that the case where the history server 18 is added to the network system 1 separately from the PC 16, 16′ as the third embodiment. However, the network monitor 40 may added to the PC 16, 16′ to make the PC 16, 16′ have a function for serving as the history server 18, whereby the same effect can be acquired as the case where the history server 18 is added to the network system 1.

In the above described embodiments, information of the service history is notified. However, service attribution information indicating attribution of service supplied may be transmitted in place of the information of the service history. The service attribution information may be transmitted together with the information of the service history.

With this arrangement, a client device can select a server which provides a desired service based on the transmitted service attribution information or both the service attribution information and the information of the service history information. As an example of the service attribution information, data information of image such as the address of an image forming server that provides an image forming service, a data format, the output form of an image, the size of the data for an image to be output, the image size, the number of copies, the direction of an image, the image output order, the resolution, the color, the number of tones, and the negative/positive inversion, or an arbitrary combination of these elements and image forming server functions such as an automatic document feeding function, a sorting function, a double-sided printing function, an image enlargement/reduction function, and an N-up function for outputting multiple images on a single sheet, or an arbitrary combination of these functions. This service attribution information can be generated from service specification information by using a service attribution table that represents a relationship between a service attribution and the specification information, which is specified in the client device in relation to the service. Further, when an enclosed relationship is established among attributions such as colors (color printing and monotone printing) and the number of print tones, if it is ascertained in advance that a value at a higher level in the relationship can be specified, the service attribution information can be determined while estimating that a value at a lower level can be specified or that for the attribution such as a paper size for which the enclosed relationship is not clear, a middle value between the maximum and the minimum values of the information specified for the services that were provided can be specified.

As is described above, according to the client server system and the method therefor of the invention, a user can select an appropriate server based on past history.

Further, according to the client server system and the method therefor of the invention, when, based on the past history, it is necessary to make a plurality of servers cooperate with each other to execute a job, the invention can provide an optimal combination of servers for the execution of the job can for a user with short time process.

What is claimed is:

1. A client server system comprising:
a plurality of servers for providing a predetermined services, respectively; and
at least one client device for requesting a service for the servers,
wherein the at least one client device comprises:
a notification request section for requesting each of the plurality of servers to transmit at least one of a service history indicating a history of a service and service attribution information indicating an attribution of a service to be provided;
a server selection section for selecting at least one of the plurality of servers based on the at least one of the service history and the service attribution information, which is transmitted from the servers in accordance with the request; and
a service request section for requesting a service for the selected server, and
wherein each of the servers comprises:
at least one of a service history generation section for generating the service history and a service attribution generation section for generating the service attribution information; and
a notification section for transmitting the at least one of the service history and the service attribution information in response to the request from the client device.

2. The client server system according to claim 1,
wherein each of service histories generated in each of servers includes auxiliary information indicates at least one of a server and a client device, which has been concerned with a service provision; and
wherein the server selection section of the at least one client device selects at least one of the servers based on the service to be requested and the auxiliary information.

3. A client device for a client server system including a plurality of services for providing predetermined services and a plurality of client devices for requesting a service for the servers, the client device comprising:
a notification request section for requesting for other client devices notification of at least one of a service history indicating a service provided by each of the plurality of servers and service attribution information indicating an attribution of the service provided by each of the plurality of servers;
a server selection section for selecting at least one of the plurality of servers based on the at least one of the service history and the service attribution information, which is transmitted from the other client devices in response to the request;
a service request section for requesting a service for the at least one selected server;
an information generation section for generating at least one of a service history and a service attribution information in relation to a service provided by the at least one selected server in accordance with the request; and
a notification section for notifying at least one of the generated service history and the generated service attribution to the other client devices in response to a request from the other client devices.

4. The client device according to claim 3,
wherein the at least one of the service history and the service attribution information includes auxiliary information indicating at least one of a server and a client device, which has been concerned with a service provision; and
wherein the server selection section of the client device selects at least one of the plurality of servers based on a service to be requested and the auxiliary information.

5. The client device according to claim 3,
wherein the information generation section generates the service history based on the at least one of the service history of the servers and the service attribution information of the servers, which is transmitted from each of the servers in accordance with the request.

6. The client device according to claim 3, wherein the information generation section generates the at least one of the service history and the service attribution information based on at least one of a server and a client device, which has been concerning with a service provided by each of the plurality of servers.

7. A client server system comprising:
a plurality of first servers for providing predetermined services, respectively;
at least one client devices for requesting a service for each of first servers;
a second server for providing for the client devices at least one of a second service history of each of first servers and second service attribution information indicating an attribution of the service provided by each of first servers,
wherein the at least one client device comprises:
a history request section for requesting the second server to notify at least one of the second service history of each of first servers and the second service attribution information of each of first servers;
a server selection section for selecting at least one of the plurality of first servers based on the at least one of the second service history and the second service attribution, which is transmitted from the second server in accordance with the request; and
a service request section for requesting a service for the at least one selected first server, and
wherein the second server comprises:
an information generation section for generating the at least one of the second service history and the second service attribution information; and
a notification section for notifying the at least one of the generated second service history and the generated second service attribution in response to the notification request from the client device.

8. The client server system according to claim 7,
wherein the one of the second service history and the second service attribution information includes auxiliary information indicating at least one of a server, which has provided a service, and a client device; and
wherein the server selection section of the client device selects at least one of the plurality of first servers based on the service to be requested and the auxiliary information.

9. The client server system according to claim 7,
wherein the second server further comprises a notification request section for requesting each of first servers to notify at least one of first service history and first service attribution information; and
wherein the information generation section of the second server generates the at least one of the second service history and the second service attribution information based non the at least one of the first service history and the first service attribution information, which is transmitted from each of the first servers in accordance with the notification request.

10. The client server system according to claim 7,
wherein the first servers and the at least one client device transmit data concerning the service to each other via a network;
wherein the second server is connected to the network;
wherein the second server further comprises a monitoring section for monitoring the data, which is transmitted by the first servers and the at least one client device; and
wherein the information generation section of the second server generates the at least one of the second service history and the second service attribution information based on the monitored data.

11. A server for providing a predetermined service for at least one client device in response to a service request from the at least one client device, the server comprising:
an information generation section for generating at least one of a service history indicating a history of a service provided by the server and service attribution information; and
an information notification section for notifying the at least one of the generated service history and the generated service attribution information in response to a notification request from the client device.

12. A client device comprising:
a notification request section for requesting each of a plurality of servers for providing predetermined services to notify at least one of a service history and service attribution information;
a server selection section for selecting at least one of the plurality of servers based on the at least one of the service history and the service attribution information, which is transmitted from each of servers in response to the notification request; and
a service request section for requesting a service for the at least one selected server.

13. A client device comprising:
a notification request section for requesting another client device to notify at least one of a service history of each of a plurality of servers for providing predetermined services and service attribution information of each of servers;
a server selection section for selecting at least one of the plurality of servers based on the at least one of the service history and the service attribution information, which is transmitted from the another client device;
a service request section for requesting a service for the at least one selected server;
an information generation section for generating at least one of a service history of the at least one selected server and a service attribution information of the at least one selected server; and
a history notification section for notifying the at least one of the generated service history and the generated service attribution that is generated in accordance with a notification request from the another client device.

14. A client device according to claim 13, wherein the information generation section generates the at least one of the service history and the service attribution information based on at least one of a server which has provided a service and a client device which has been received the service.

15. A history server comprising:
a storage section for storing at least one of a service history indicating a history of a service provided from each of a plurality of servers to a client device and a service attribution information indicating an attribution of the service; and
a notification section for notifying the at least one of the stored service history and the stored service attribution information to the client device.

16. The history server according to claim 15, further comprising a monitoring section for monitoring data concerning a service, which is transmitted between each of the servers and the client device via a network,
wherein the storage section generates the at leas one of the service history and the server attribution information based on the monitored data.

17. A service notification method for a client server system including a plurality of servers for providing predetermined services, respectively and at least one client device for requesting a service for the servers, the method comprising the steps of:
requesting a notification of at least one of a service history and service attribution information from the at least one client device to each of serves;
notifying the at least one of the service history and the service attribution information from each of serves to the client device in response to the notification requesting step;
selecting at least one of the plurality of servers by the client device based on the at least one of the service history and the service attribution information to request a service for the at least one selected server; and
generating at least one of another service history and another service attribution information by the selected server.

18. A server selection method for a client server system including a plurality of servers for providing predetermined services, respectively and at least one client device for requesting a service for the servers, the method comprising the steps of:
requesting each of servers to notify at least one of a service history and service attribution information; and
selecting at least one of the plurality of servers based on the at least one of the service history and the service attribution information to request a service for the at least one selected server.

19. A service notification program for a client server system including a plurality of servers for providing predetermined services, respectively and at least one client device for requesting a service for the servers, the program making a computer of each of servers perform the steps of:
generating at least one of a service history and an service attribution information, which is concerned with a service provided for the client device; and
notifying the at least one of the service history and the service attribution information in response to a notification request from the client device.

20. A service selection program for a client server system including a plurality of servers for providing predetermined services, respectively and at least one client device for requesting a service for the servers, the program making a computer of each of servers perform the steps of:
requesting each of servers to notify at least one of a service history and a service attribution information;
selecting at least one of the plurality of servers based on the service history and the service attribution information, which is transmitted from each of servers in response to the notification requesting step;
requesting a service for the at least one selected server.

21. A service notification program for a client server system including a plurality of servers for providing predetermined services, respectively and at least one client device for requesting a service for the servers, the program making a computer of each of servers perform the steps of:
generating at least one of a service history of a service provided by other servers and/or a service attribution indicating of the service; and
notifying the at least one of the service history and the service attribution in accordance with a notification request from the client device.
